(19) United States
(12) Patent Application Publication
(10) Pub. No.: US 2017/0114577 A1
(43) Pub. Date: Apr. 27, 2017

(54) TOUCH-SENSITIVE DOOR HANDLE WITH TEMPERATURE SENSING

(71) Applicant: METHODE ELECTRONICS, INC., Chicago, IL (US)

(72) Inventors: Thomas C. BESHKE, SR., St. Clair Shores, MI (US); Ronald D. SHPAKOFF, Brighton, MI (US)

(21) Appl. No.: 15/289,707

(22) Filed: Oct. 10, 2016

Related U.S. Application Data
(60) Provisional application No. 62/246,731, filed on Oct. 27, 2015.

(51) Int. Cl. E05B 81/76; E05B 81/16; E05B 81/04; G06F 3/044; E05B 47/00

(52) U.S. Cl. CPC E05B 81/76; G06F 3/044; E05B 47/0001; E05B 81/04; E05B 81/16; E05B 2047/0053; E05B 2047/0054; E05B 2047/0056

(57) ABSTRACT

A touch sensing system includes one or more touch sensors, a temperature sensor, an output driver and a controller configured to set the output driver to a first state when the controller deems the sensor(s) to be in a touched state and to set the output driver to a second state when the controller deems the sensor(s) to be in a untouched state. The controller sets a touch sensitivity threshold for the sensors as a function of temperature data the controller receives from the temperature sensor.

### CROSS-REFERENCE TO RELATED APPLICATIONS

This application claims benefit of U.S. Provisional Patent Application No. 62/246,731, filed Oct. 27, 2015, and incorporates by reference the disclosure thereof in its entirety.

### BACKGROUND AND SUMMARY OF THE DISCLOSURE

Capacitive sensors often are used in entry systems for automobiles and other vehicles. Such entry systems may include one or more capacitive sensors embedded in a door handle to sense the presence of a user's hand or fingers at or proximate the door handle. The sensors may be associated with a controller that selectively locks and unlocks the vehicles does as a function of actuation of one or more of the sensors. Also, such systems may include a plurality of capacitive sensors disposed a window or body panel. A user may unlock the vehicle by touching the sensors in a predetermined sequence.

Capacitive sensors may be desirable in vehicle entry system applications for several reasons. For example, they typically have no moving parts that can wear out. Also, they can more readily be integrated into structures such as door handles in a manner that provides protection from the environment than can electromechanical switches.

Nevertheless, the use of capacitive touch sensors in vehicle keyless entry systems has certain shortcomings. For example, it can be difficult to calibrate capacitive sensors to reliably respond to touch by both gloved and ungloved hands. Also, capacitive sensors used in vehicle entry systems tend to be placed in locations where they are prone to false actuation due to the effects of contaminants such as water, road salt, dirt, other particulates, and the like. A capacitive sensor that is calibrated to detect a gloved hand may be overly sensitive to ungloved hands and contaminants and, therefore, may cause unwanted actuations of a controlled device. Conversely, a capacitive sensor that is calibrated to detect the presence of an ungloved hand may be unable to reliably detect an ungloved hand and, therefore, not cause actuations of a controlled device when desired.

The present disclosure shows and describes an illustrative system including touch sensors and a temperature sensor. In an embodiment, the system could be a vehicle entry system, and the touch sensors could be disposed in or on a vehicle door handle. The touch sensors may be embodied as capacitive sensors, field effect sensors, or other forms of sensors. The temperature sensor may sense, for example, ambient air temperature outside the vehicle. The touch sensors and temperature sensor provide input to a controller. The controller may adjust the sensitivity of the touch sensors as a function of the sensed temperature. For example, the controller may decrease the sensitivity of the touch sensors when the temperature sensor detects ambient air temperature above a predetermined threshold. Conversely, the controller may increase the sensitivity of the capacitive sensors when the temperature sensor detects ambient air temperature below a predetermined threshold. Other embodiments could involve additional inputs to the controller and use other types of sensors.

### BRIEF DESCRIPTION OF THE DRAWINGS

FIG. 1 is a block diagram of an illustrative vehicle entry system including a microcontroller receiving input from one or more capacitive sensors disposed in or on a door handle and a temperature sensor, and providing output to one or more output drivers; and

FIG. 2 is a flow chart showing an illustrative method of operating the system of FIG. 1 to set a driver output to an idle state or an active state.

### DETAILED DESCRIPTION OF THE DRAWINGS

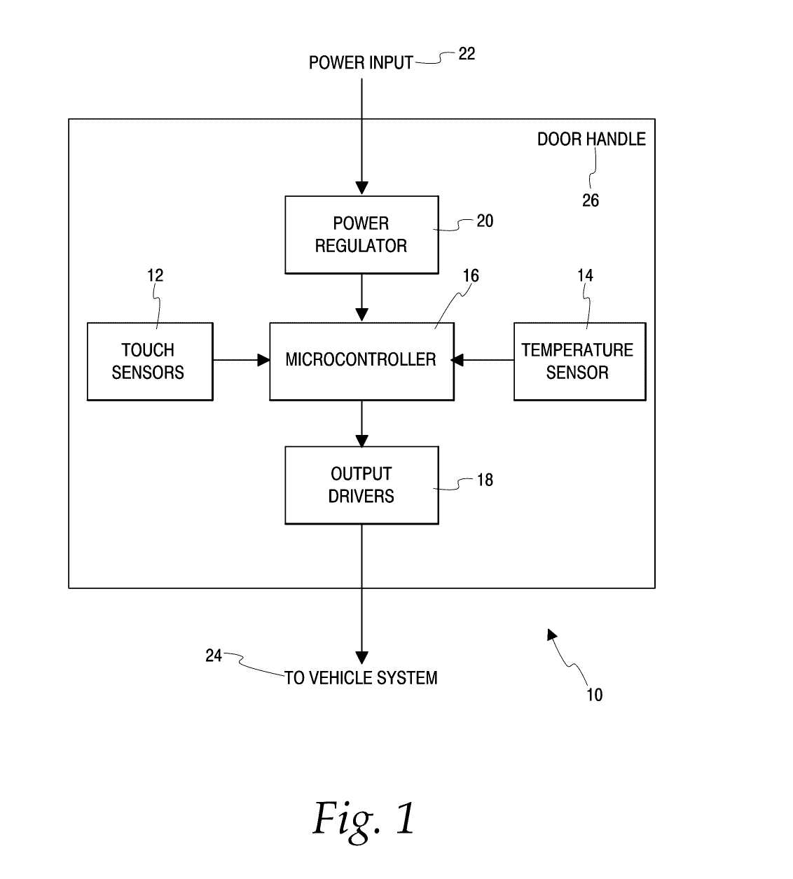

FIG. 1 depicts an illustrative vehicle entry system 10 including one or more touch sensors 12, a temperature sensor 14, a microcontroller 16 receiving inputs from the touch sensor(s) and one or more output drivers 18 receiving output from the controller. The system 10 may also include a power regulator 20 receiving power from a power supply or input 22 and providing power to the controller 16. The system 10 may provide output, via the output driver(s) 18, to one or more vehicle systems 24.

The touch sensors 12 may be embodied as capacitive sensors, field effect sensors, or other forms of sensors. Illustrative examples of field effect sensors are disclosed in U.S. Pat. Nos. 5,594,222, 6,310,611, and 6,320,282, the disclosure of which are incorporated in their entireties herein by reference. The touch sensors 12 may include a touch pad comprising one or more sensing electrodes. The sensing electrode(s) may receive input from and/or provide input to the microcontroller 16, as discussed further below. The touch sensors 12 may be embedded in or otherwise disposed in or on a door handle 26 of a vehicle (not shown). The door handle may be embodied as a conventional door handle distinct from and attached to a body panel of the vehicle, or it may be embodied as a portion of the vehicle body configured to receive a human hand or portion thereof for pulling and/or pushing a door or other panel between first and second, for example, open and closed, positions. In other embodiments, the touch sensors 12 may be embedded in or otherwise disposed in or on another portion of the vehicle, for example, a body panel, accessory, or window.

The temperature sensor 14 may be configured to detect, for example, ambient air temperature. The temperature sensor 14 may be disposed in or on the door handle 26. Alternatively, the temperature sensor 14 may be located elsewhere on the vehicle, either near or distant from the door handle 26. The temperature sensor 14 need not be dedicated to the system 10. For example, the temperature sensor 14 also could provide input to other systems (not shown) of the vehicle, for example, a temperature display on the vehicle's instrument panel.

The controller 16 may be, for example, a microcontroller. The controller 16 may be configured in hardware and/or software to provide drive or excitation signals to the touch sensors 12, to receive signals from the touch sensors, and/or to determine whether or not the touch sensors should be deemed to have been touched as a function of one or more of the foregoing signals. The controller 16 also may be configured to receive signals from the temperature sensor 14 and to determine whether or not the touch sensors 12 should be deemed to have been touched as a function of the signals received from the temperature sensor 14. The function of the controller 16 will be discussed further below.

The controller 16 may further be configured to provide one or more signals to one or more output drivers 18. These signals may place the respective output drivers 18 in an idle state or an active state as will be discussed further below. The output drivers 18 may be used to control one or more vehicle systems 24. With an output driver 18 in the idle state, the respective vehicle system 24 is unaffected. With the output driver 18 in the active state, the state of the vehicle system 24 may be changed in predetermined manner. For example, a first output driver 18 might be configured to change the state of a door lock from locked to unlocked, and a second output driver 18 might be configured to change the state of the door lock from unlocked to locked. With either of the first and second output drivers 18 in an idle state, the respective output driver causes no change in the state of the door lock. With the first output driver in an active state, the first output driver causes the state of the lock, if initially locked, to change from locked to unlocked or, if initially unlocked, to remain unlocked. With the second output driver in an active state, the second output driver causes the state of the lock, if initially unlocked, to change from unlocked to locked or, if initially locked, to remain locked.

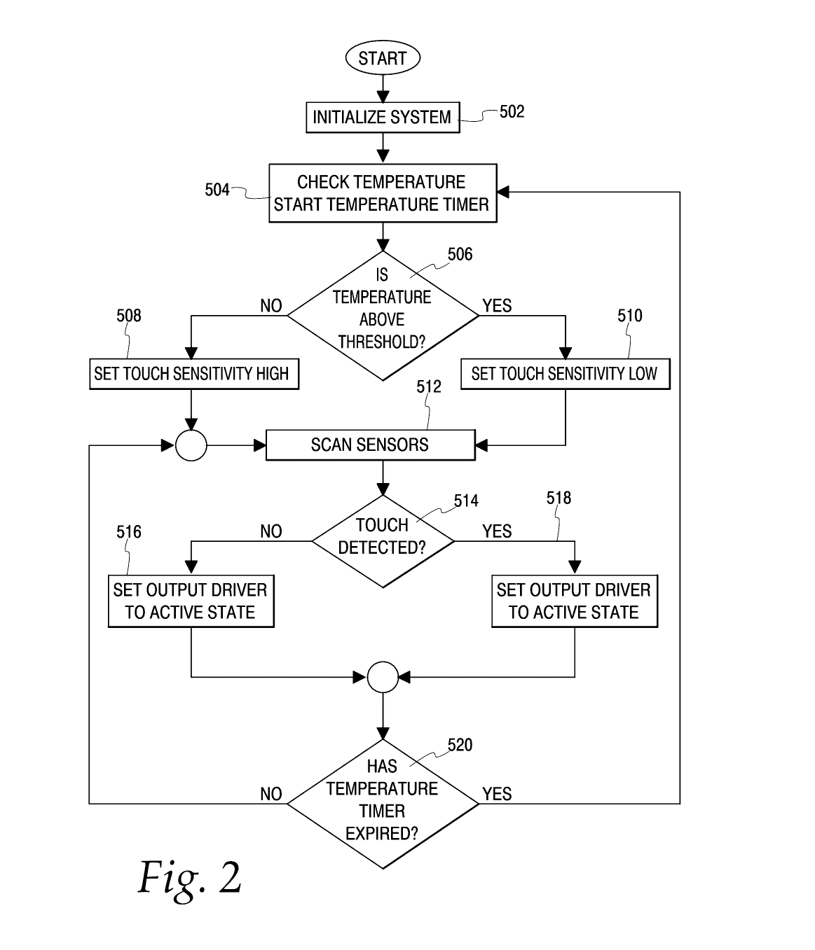

FIG. 2 is a flowchart depicting an illustrative algorithm 500 for operating system 10. At step 502, the system 10 is initialized. This step may involve initializing the controller 16 to provide drive or excitation signals to the touch sensors 12. This step also may involve obtaining a baseline output from the touch sensors 12. For example, if the touch sensors 12 are capacitive sensors, this step may involve determining a baseline capacitance for the sensors, that is, the sensor capacitance without a stimulus touching or near the sensor.

At step 504, a temperature signal is obtained from the temperature sensor 14. As set forth above, the temperature sensor 14 may be located and/or configured to detect, for example, ambient temperature air temperature about the touch sensors 12, a structure (for example, a door handle) in or upon which the touch sensors are disposed, or elsewhere about the system 10. The controller 16 may convert the signal received from the temperature sensor 14 to a corresponding temperature. Also at step 504, the controller initiates a temperature timer configured to time out after a predetermined amount of time. The predetermined time could be selected as desired. For example, the predetermined time could be selected as about one minute or any greater or lesser time s might be desired.

At step 506, the controller 16 compares the temperature obtained in step 504 to a predetermined temperature. If the temperature obtained in step 504 is below the predetermined temperature, the controller 16 at step 508 sets to a first level the touch detection threshold used by the controller in determining whether to deem a touch to have occurred at the touch sensors 12. If the temperature obtained in step 504 is above the predetermined temperature, the controller 16 at step 510 sets to a second level the touch detection threshold used by the controller to determining whether to deem a touch to have occurred at the touch sensors 12. The predetermined temperature may be selected as desired. In certain embodiments, the predetermined temperature could be 32 degrees F. or any temperature between, for example, 22 degrees F. and 42 degrees F., or a greater or lower temperature.

At step 512, the controller 16 scans the output(s) of the touch sensor(s) 12.

At step 514, the controller 16 determines whether to deem a touch to have occurred at the touch sensor(s) 12 as a function of the output from the touch sensors obtained in step 512 and the particular touch detection threshold set at step 508 or 510. For example, if the touch sensor 12 is a capacitive sensor, the controller 16 compares the capacitance value obtained at step 512 with the baseline capacitance obtained at step 502 to obtain a delta value. The controller 16 then compares the delta value with the applicable touch detection threshold set at step 508 or step 510. If the delta value is less than the applicable touch detection threshold, the controller 16 at step 516 provides an output to the output driver 18 setting the output driver to an idle state. If the delta value is equal to or exceeds the applicable touch detection threshold, the controller 16 at step 518 provides an output to the output driver 18 setting the output driver to an active state.

If at step 514 the controller 16 has deemed a sensor not to be touched, the controller sets an output driver 18 corresponding to the sensor to an idle state or, if previously in the idle state, maintains the output driver in the idle state. For example, the controller 16 may set the an output driver 18 controlling the state of an electric door unlatching mechanism to an idle state or cause it to remain in an idle state when the controller deems a corresponding sensor located in a door handle to be in an untouched state, thereby placing or maintaining the door unlatching mechanism in a latched state.

Similarly, if at step 514 the controller 16 has deemed a sensor to be touched, the controller sets an output driver 18 corresponding to the sensor to an active state or, if previously in the active state, maintained in the active state. Once the controller has set the output driver 18 to the active state, the output driver may remain in the active state for a predetermined time, indefinitely, or until the controller 16 next deems the relevant sensor to be in an untouched state. The predetermined time may be as short as instantaneous such that the output driver immediately returns to the idle state after having toggled to the active state. For example, the controller 16 may set an output driver 18 controlling the state of an electric door unlatching mechanism to an active state when the controller deems a corresponding sensor located in a door handle to be in a touched state, thereby placing the door unlatching mechanism in an unlatched state. Further, the controller 16 may maintain the output driver 18 in the active state for a predetermined time or indefinitely once set to the active state, thereby maintaining the door unlatching mechanism in the unlatched state. Alternatively, the controller 16 may set the output driver 18 to the idle state after a predetermined amount of time or when the controller 16 next deems the relevant sensor to be in an untouched state.

In an embodiment, as suggested above, the controller may cause the output driver(s) 18 to change state in response to the controller deeming a single sensor to be in a touched condition or an untouched condition.

In another embodiment, the controller 16 may instead cause the output drivers to change state in response to the controller deeming a plurality of sensors to have been touched in a predetermined sequence and/or according to a predetermined temporal scheme.

For example, without limitation, the controller 16 may set the output driver to an active state when the controller deems a plurality of sensors to have been touched in a random or predetermined sequence, within a predetermined time period. In another embodiment, the controller 16 may set the output driver 18 to an active state when the controller deems a plurality of sensors to have been touched in a random or predetermined sequence within a first predetermined time period and no sensor to have been touched within a second predetermined time period. In a further embodiment, the controller 16 may set the output driver 18 to an active state when the controller deems one or more sensors to have been touched in a random or predetermined sequence within a first predetermined time period, no sensor to have been touched within a second predetermined time period, and one or more sensors to have been touched in a random or predetermined sequence within a third predetermined time period.

At step 520, the controller 16 determines whether the temperature timer initially set at step 504 has expired or timed out. If the temperature timer has timed out, the algorithm 500 reverts to step 504. If the timer has not timed out, the algorithm 500 reverts to step 512. The temperature timer provides hysteresis to mitigate toggling of the touch sensitivity when the ambient or sensed temperature is near the predetermined threshold temperature. Such hysteresis could be implemented in the algorithm in other ways, as well.

Although the foregoing discussion of the flow chart of FIG. 2 describes an algorithm as being implemented by the controller 16, any or all of the steps of the algorithm could be distributed among numerous controllers and/or performed by other structures. For example, without limitation, the output driver 18 could be configured to maintain itself in an active state for a predetermined time, indefinitely, or instantaneously in response to a change-of-state signal from the controller 16, without further input from the controller 16.

In an embodiment, either or both of the high and low touch sensitivity thresholds could be adjustable through a smartphone coupled to the system 10 or through a user-vehicle interface coupled to the system 10. This feature would enable a user to tailor the sensitivity thresholds as may be desired or deemed appropriate.

The foregoing principles and structures are not limited to use in connection with vehicle entry systems. They could be applied to any form of touch sensing system wherein it may be desirable to set touch detection thresholds as a function of temperature.

1. A touch detection system comprising:
a controller;
a touch sensor providing to the controller signals related to capacitance proximate the touch sensor;
a temperature sensor providing to the controller signals related to temperature;
the controller configured to deem whether the touch sensor has been touched based on the signals received from the touch sensor and the signals received from the temperature sensor.

2. The system of claim 1 wherein:
the controller deems whether the touch sensor has been touched according to a first criterion if the signal from the temperature sensor is indicative of the temperature at the temperature sensor being below a predetermined temperature; and
the controller deems whether the touch sensor has been touched according to a second criterion if the signal from the temperature sensor is indicative of the temperature at the temperature sensor being equal to or greater than the predetermined temperature.

3. The system of claim 2 wherein
the first criterion involves a change in capacitance greater than or equal to a first threshold, and
the second criterion involves a change in capacitance greater than or equal to a second threshold.

4. The system of claim 3 wherein the second threshold is greater than the first threshold.

5. The system of claim 4 wherein the controller is configured to deem whether the touch sensor has been touched according to one of the first criterion and the second criterion for at least a predetermined period of time before deeming whether the touch sensor has been touched according to the other of the first criterion and the second criterion.

6. The system of claim 5 further comprises an output driver, wherein the controller causes the output driver to change state from a first state to a second state in response to the controller having deemed the touch sensor to have been touched.

7. The system of claim 6, further comprising a controlled device, wherein the output driver actuates the controlled device when the output driver changes state from the first state to the second state.

8. The system of claim 7, wherein the controlled device is a door lock.

9. The system of claim 8 further comprising a door handle, wherein the touch sensor is associated with the door handle.

10. The system of claim 9 wherein the touch sensor is disposed on the door handle.

11. The system of claim 9 wherein the touch sensor is disposed within the door handle.

12. The system of claim 5 further comprising a door handle, wherein the touch sensor is associated with the door handle.

13. The system of claim 12 wherein the touch sensor is disposed on the door handle.

14. The system of claim 12 wherein the touch sensor is disposed within the door handle.

15. A method of operating a controlled device using a system comprising a controller, a touch sensor, and a temperature sensor, the method comprising the steps of:
providing to the controller signals related to capacitance proximate the touch sensor;
providing to the controller signals related to temperature proximate the temperature sensor;
deeming whether the touch sensor has been touched according to a first criterion if the signal from the temperature sensor is indicative of the temperature at the temperature sensor being below a predetermined temperature; and
deeming whether the touch sensor has been touched according to a second criterion if the signal from the temperature sensor is indicative of the temperature at the temperature sensor being equal to or greater than the predetermined temperature.

16. The method of claim 15 wherein
the first criterion involves a change in capacitance greater than or equal to a first threshold, and
the second criterion involves a change in capacitance greater than or equal to a second threshold.

17. The method of claim 16 wherein the second threshold is greater than the first threshold.

18. The method of claim 17 further comprising the step of deeming whether the touch sensor has been touched according to one of the first criterion and the second criterion for at least a predetermined time before deeming whether the touch sensor has been touched according to the other of the first criterion and the second criterion.

19. The method of claim 18 wherein the system further comprises an output driver, the method further comprising the step of changing the state of the output driver from a first state to a second state in response to deeming the touch sensor to have been touched.

20. The method of claim 18 wherein the system further comprises a door handle, the touch sensor associated with the door handle.
